(19) United States
(12) Patent Application Publication
(10) Pub. No.: US 2026/0158961 A1
(43) Pub. Date: Jun. 11, 2026

(54) APPARATUS AND METHOD FOR MAINTAINING CHARGER

(71) Applicant: SK Signet Inc., Yeonggwang-gun (KR)

(72) Inventors: Tae Gyu KIM, Seoul (KR); Young Su PARK, Seoul (KR); Dae Geun LEE, Incheon (KR)

(21) Appl. No.: 19/409,574

(22) Filed: Dec. 4, 2025

(30) Foreign Application Priority Data
Dec. 6, 2024 (KR) 10-2024-0180970

(51) Int. Cl. B60L 53/68; B60L 53/30; B60L 53/31; B60L 53/67

(52) U.S. Cl. CPC B60L 53/68; B60L 53/305; B60L 53/31; B60L 53/67; B60L 2270/40

(57) ABSTRACT

An apparatus and a method for maintaining a charger which perform state monitoring, remote reset, setting change, log analysis, and update at a component level of a charger are disclosed. An apparatus for maintaining a charger according to an exemplary embodiment may include a communication unit which communicates with an external device and a controller which performs at least one of state monitoring, remote reset, setting change, log analysis, and update for one or more components included in a charger, by means of the communication unit.

### CROSS-REFERENCE TO RELATED APPLICATIONS

This application claims the priority of Korean Patent Application No. 10-2024-0180970 filed on Dec. 6, 2024, in the Korean Intellectual Property Office, the disclosure of which is incorporated herein by reference.

### BACKGROUND

### Field

The present disclosure relates to an apparatus and a method for maintaining a charger using a charger integrated support system (CISS).

### Description of the Related Art

The charger integrated support system (CISS) is an integrated support system which is designed to increase maintenance and management efficiency of an electric vehicle charger system. This system helps to monitor a state of a component of a charger in real time and remotely solve a problem and provide a repair guide when an error occurs. Further, this system automates software updating and maintenance of the charger, thereby reducing a burden of an operator of the charger and ensuring a stability of the system. The CISS supports a remote reset function, log analysis, and over-the-air (OTA) update to smoothly operate the charger.

The CISS allows a charger network to be managed at the center and consistently optimize a performance and a state of the charger by means of data collection and analysis. By doing this, the CISS provides the charger operator with real-time notification and supports the charger operator to establish a predictable maintenance plan. This system ensures an efficient and stable operation of the charger and plays an important role in developing an electric vehicle charge infrastructure.

### SUMMARY

An object of the present disclosure is to provide an apparatus and a method for maintaining a charger which perform state monitoring, remote reset, setting change, log analysis, and update at a component level of a charger.

According to an aspect, a charger maintenance apparatus may include a communication unit which communicates with an external device; and a controller which performs at least one of state monitoring, remote reset, setting change, log analysis, and update for one or more components included in a charger, by means of the communication unit.

The charger may be configured by a power cabinet to supply power and one or more dispensers which are connected to the power cabinet to perform charging.

The controller may communicate with one or more dispensers through the communication unit.

When an update is performed, the controller may determine the power cabinet as a master cabinet according to a predetermined criterion to update one or more components included in the power cabinet and one or more components included in one or more dispensers connected to the power cabinet.

When the update is performed, the controller may determine at least one of one or more dispensers as a master dispenser and determine the others as slave dispensers, according to a predetermined criterion.

The master dispenser may update one or more components included therein and one or more components included in the power cabinet connected thereto and the slave dispensers may update one or more components included therein.

The controller may determine the master dispenser based on a CPU usage (%), a memory usage (%), and a network occupancy (%) of each of one or more dispensers.

The controller may determine at least two or more master dispensers and determine one of at least two or more master dispensers as a primary master dispenser which updates one or more components included in the power cabinet.

The controller may determine the other one or more master dispensers excluding the primary master dispenser, among at least two or more master dispensers, as a secondary master dispenser which simulates the same update process as the primary master dispenser.

If an error occurs during the update of the primary master dispenser, the controller may call an update process at a predetermined reference timing from any one of one or more secondary master dispensers to replace the update of the primary master dispenser.

The controller may compare the update process of the primary master dispenser at the predetermined reference timing and the called update process of the secondary master dispenser and if the update processes are different, the controller may replace the update of the primary master dispenser using the called update process and if the update processes are the same, call the update process of another secondary master dispenser again.

The controller may determine an order of updating one or more components included in the power cabinet and the dispenser according to a predetermined mode.

The controller may receive number information and ID order information of each of one or more components included in the power cabinet and the dispenser from a user, through the communication unit.

The controller may transmit update status information for one or more components included in the power cabinet and the dispenser to a user through the communication unit.

The controller may selectively update some of one or more components included in the power cabinet and the dispenser according to a predetermined criterion.

According to an aspect, a charger maintenance method which is carried out on a computing device including one or more processors and a memory which stores one or more programs executed by the one or more processors may include a communication step of communicating with an external device; and a control step of performing at least one of state monitoring, remote reset, setting change, log analysis, and update for one or more components included in a charger, by means of the communication step.

The charger may be configured by a power cabinet to supply power and one or more dispensers which are connected to the power cabinet to perform the charging.

In the communication step, communication may be performed with one or more dispensers.

In the control step, when the update is performed, the power cabinet is determined as a master device according to a predetermined criterion to update one or more components included in the power cabinet and one or more components included in one or more dispensers connected to the power cabinet.

In the control step, when the update is performed, at least one of one or more dispensers may be determined as a master dispenser and the others may be determined as slave dispensers according to a predetermined criterion.

The master dispenser may update one or more components included therein and one or more components included in the power cabinet connected thereto and the slave dispensers may update one or more components included therein.

In the control step, a master dispenser may be determined based on a CPU usage (%), a memory usage (%), and a network occupancy (%) of each of one or more dispensers.

In the control step, at least two or more master dispensers may be determined and one of the at least two or more master dispensers may be determined as a primary master dispenser which updates one or more components included in the power cabinet.

In the control step, the other one or more master dispensers excluding the primary master dispenser, among at least two or more master dispensers, may be determined as a secondary master dispenser which simulates the same update process as the primary master dispenser.

In the control step, when an error occurs during the update of the primary master dispenser, an update process at a predetermined reference timing is called from any one of one or more secondary master dispensers to replace the update of the primary master dispenser.

In the control step, the update process of the primary master dispenser at the predetermined reference timing and the called update process of the secondary master dispenser may be compared and if the update processes are different, the update of the primary master dispenser may be replaced using the called update process and if the update processes are the same, the update process of another secondary master dispenser may be called again.

In the control step, an update order of one or more components included in the power cabinet and the dispenser may be determined according to a predetermined mode.

In the control step, number information and ID order information for each of one or more components included in the power cabinet and the dispenser may be received from the user.

In the control step, update status information for each of one or more components included in the power cabinet and the dispenser may be transmitted to the user.

In the control step, some of one or more components included in the power cabinet and the dispenser may be selectively updated according to a predetermined criterion.

According to an exemplary embodiment, an abnormal state of a charger is detected in real time and a notification is immediately transmitted to a CS engineer through a mobile application to promptly maintain the charger. Further, remote setting, resetting, log analysis, and customized update are provided to improve a function of the charger and reduce errors, thereby supporting efficient operations.

The effects of the present disclosure are not limited to the aforementioned effects, and various other effects are included in the present specification.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a diagram of a charger maintenance apparatus according to an exemplary embodiment;

FIG. 2 is an exemplary diagram for explaining an operation environment of a charger maintenance apparatus according to an exemplary embodiment;

FIG. 3 is an exemplary view for explaining a structure of a power cabinet and a dispenser according to an exemplary embodiment;

FIGS. 4, 5, 6, 7, 8, 9 and 10 are exemplary views for explaining an operation of a charger maintenance apparatus according to an example; and

FIG. 11 is a flowchart illustrating a charger maintenance method according to an exemplary embodiment.

### DETAILED DESCRIPTION OF EXEMPLARY EMBODIMENTS

Hereinafter, an exemplary embodiment of the present invention will be described in detail with reference to the accompanying drawings. In the description of the present disclosure, a detailed description of known configurations or functions incorporated herein will be omitted when it is determined that the detailed description may make the subject matter of the present disclosure unclear. Further, the terms to be described below are defined considering the functions in the present disclosure and may vary depending on the intention or usual practice of a user or operator. Accordingly, the terms need to be defined based on details throughout this specification.

Hereinafter, exemplary embodiments of a charger maintenance apparatus and a method thereof will be described in detail with reference to drawings.

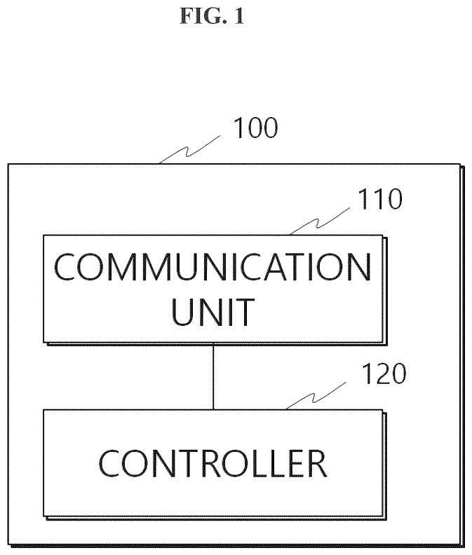

FIG. 1 is a diagram of a charger maintenance apparatus according to an exemplary embodiment.

According to an exemplary embodiment, the charger maintenance apparatus 100 may include a communication unit 110 which communicates with an external device and a controller 120 which performs at least one of state monitoring, remote reset, setting change, log analysis, and update for one or more components included in the charger through the communication unit 110.

For example, the charger maintenance apparatus 100 is an apparatus for supporting stable and efficient operations of an electric vehicle charger and provides a function of collecting state information by monitoring components of the electric vehicle charger in real time and remotely solving a problem when an error occurs. The charger maintenance apparatus 100 not only checks a state of the charger, but also supports setting change, log analysis, and over-the-air (OTA) update to support maintenance of an optimized performance of the charger.

The charger maintenance apparatus 100 may promptly resolve a problem of the charger through a remote reset and setting function at a component level without visiting the site and identify a cause of the error by analyzing accumulated log data and take precautions. Specifically, software is remotely upgraded by updating OTA, thereby improving a performance of the charger and reflecting a latest technology. The charger maintenance apparatus 100 may be a cloud-based CISS server. Accordingly, the charger maintenance apparatus 100 may perform a real-time data processing and control function through a CISS agent installed in the charger.

According to the present disclosure, the charger may be configured by a power cabinet to supply power and one or more dispensers which are connected to the power cabinet to perform charging.

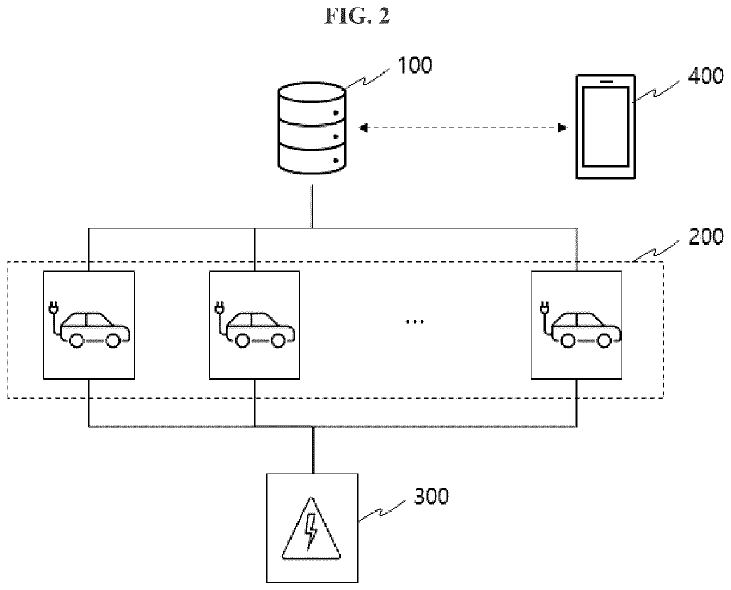

Referring to FIG. 2, the charger maintenance apparatus 100 may be connected to the charger configured by one or more dispensers 200 and the power cabinet 300. Further, the charger maintenance apparatus 100 may communicate with the user terminal to exchange state information and control information.

The software of the electric vehicle charger may be updated based on a connection structure of the dispenser and the power cabinet. To this end, the charger maintenance apparatus 100 may control the update by allocating a master authority to a specific dispenser and allowing the power cabinet to serve as a slave, or in contrast, allocating a master authority to the power cabinet and allowing the connected dispensers to serve as slaves.

For example, the charger may have various connection structures. For example, the charger may be implemented in various forms, such as a structure in which a dispenser and a power cabinet are integrally configured, a structure (2 DP: 1 PC) configured by two dispensers and one power cabinet, or a structure (4 DP: 1 PC) configured by four dispensers and one power cabinet. The charger may be updated flexibly and effectively according to various connection forms as described above.

According to the exemplary embodiment, the controller 120 may communicate with one or more dispensers through the communication unit 110.

The charger maintenance apparatus 100 may be a CISS server which is operated on the cloud and the controller 120 communicates with the dispenser 200 through the communication unit 110 to support the operation and maintenance of the dispenser 200. The dispenser 200 may include a CISS agent and provide user interface and charging control. Further, the dispenser 200 may transmit state information and setting data of the charger to the communication unit 110 of the charger maintenance apparatus 100.

The charger maintenance apparatus 100 may monitor state information collected from each component of the charger system through the communication with the dispenser 200 and transmit setting change and remote control instruction to the dispenser 200. During this communication process, data may be exchanged in real time based on HMI SW of the dispenser 200 and a protocol installed in a main board and remotely update software and solve the problem by utilizing the over-the-air (OTA) manner if necessary.

The charger maintenance apparatus 100 may cooperate with the dispenser 200 to ensure the stability of the charger system and enable a rapid maintenance task. Specifically, when an error occurs in the dispenser, the charger maintenance apparatus 100 analyzes data in real time to diagnose the problem and take an appropriate response measure, thereby supporting an efficient operation of the charging infrastructure.

According to an example, the controller 120 may determine at least one of the power cabinet and one or more dispensers as a master which mainly performs the update. For example, the controller 120 may determine the power cabinet as a master. As another example, the controller 120 may determine at least one of one or more dispensers as a master. As another example, if the charger has a structure in which the power cabinet and the dispenser are integrated, this may be determined solely as a master without having a separate slave (dependent) device.

According to the exemplary embodiment, when an update is performed, the controller 120 may determine the power cabinet to update one or more components included in the power cabinet and one or more components included in one or more dispensers connected to the power cabinet, according to a predetermined criterion. According to an example, the power cabinet may share an update status with the charger maintenance apparatus 100 in association with the dispenser connected thereto and inform the power cabinet and all the connected dispensers of an update progress status. During the update, all the dispensers connected to the power cabinet maintain the update screen state and restrict the user's access until the update of the power cabinet is completed.

According to the exemplary embodiment, when the update is performed, the controller 120 may determine at least one of one or more dispensers as a master dispenser and determine the others as slave dispensers, according to a predetermined criterion. Here, the master dispenser may update one or more components included therein and one or more components included in the power cabinet connected thereto and the slave dispensers may update one or more components included therein.

According to the exemplary embodiment, the controller 120 may determine the master dispenser based on a CPU usage (%), a memory usage (%), and a network occupancy (%) of each of one or more dispensers. For example, the controller 120 may monitor a state of each dispenser for a predetermined time to preferentially select a dispenser having a smallest summed value of the CPU usage (%), the memory usage (%), and the network occupancy (%).

According to an example, the dispenser which is determined as a master dispenser may share an update status of the power cabinet with the charger maintenance apparatus 100 in association with the dispenser connected to the power cabinet and inform all the connected dispensers of an update progress status. During the update, all the dispensers connected to the power cabinet maintain the update screen state and restrict the user's access until the update of the power cabinet is completed.

According to the exemplary embodiment, the controller 120 may determine at least two or more master dispensers. For example, when it is necessary to select a plurality of master dispensers, the controller 120 may compare similarities of three status values of the CPU usage (%), the memory usage (%), and the network occupancy (%) of each dispenser to select a dispenser having a similar summed value or having change patterns of the value which are similar to each other by a threshold value or more.

According to the exemplary embodiment, the controller 120 may determine one of at least two or more master dispensers, as a primary master dispenser which updates one or more components included in the power cabinet. Further, the controller 120 may determine the other one or more master dispensers excluding the primary master dispenser, among at least two or more master dispensers, as a secondary master dispenser which simulates the same update process as the primary master dispenser. For example, when the plurality of master dispensers is selected, the primary master dispenser may actually perform the update and the secondary master dispensers may simultaneously simulate the same process in real time in the background.

According to the exemplary embodiment, when an error occurs during the update of the primary master disperser, the controller 120 may call an update process at a predetermined reference timing from any one of one or more secondary master dispensers to replace the update of the primary master dispenser. For example, if an error occurs during the update of the primary master dispenser, the controller 120 may call background process data performed in the secondary master dispenser as a state before a predetermined time to recover the error. During this process, update data of each master dispenser is compared with one another and if the inconsistency between data is identified, data of the other master dispenser is sequentially referred to transfer the update process.

According to the exemplary embodiment, the controller 120 may compare the update process of the primary master dispenser at a predetermined reference timing and the update process of the called secondary master dispenser. If the processes are different, the update of the primary master dispenser may be replaced by the called update process and if the processes are the same, the update process of another secondary master dispenser may be called again.

During the process of performing the update in the charger system, the controller 120 may compare the update processes of the primary master dispenser and the called secondary master dispenser. At this time, the controller 120 may determine whether the update processes of two dispensers are the same and if two processes are different, the controller may replace the called update process of the secondary master dispenser with the update process of the primary master dispenser. This is a measure to suppress the error occurring in the primary master dispenser or an update failure and a part in which an error occurs may be safely modified based on assumption that the update process of the secondary master dispenser normally operates.

In contrast, if the update processes of two dispensers are the same, the controller 120 may determine that the same error occurs in two dispensers. In this case, the same error may be highly likely to occur simultaneously in two dispensers, so that the controller 120 may find another secondary master dispenser to call the update process of the corresponding dispenser again. By doing this, a reliable update path may be ensured by selecting an additional dispenser so as not to cause the same error and the system stability may be maintained. This process ensures the reliability and the efficiency of the charger system and provides a function of quickly and accurately replacing the process if an error occurs.

According to the exemplary embodiment, the controller 120 may determine an update order of one or more components included in the power cabinet and the dispenser according to a predetermined mode.

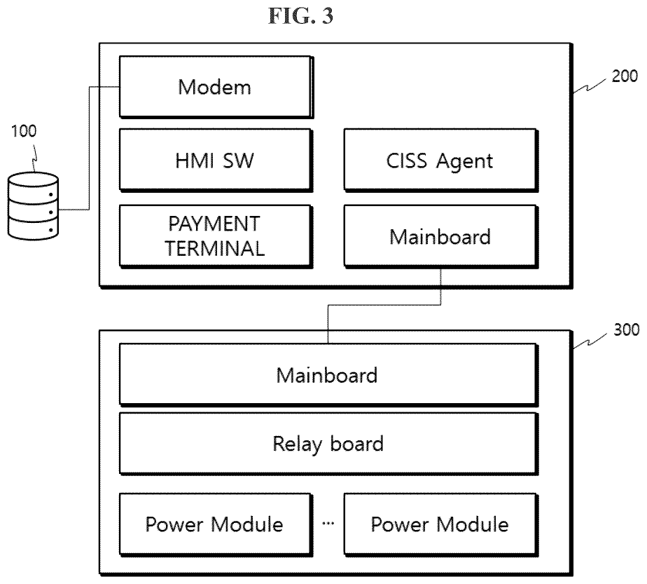

When the charger system is updated, the controller 120 may determine the update order of the components included in the power cabinet and the dispenser according to a predetermined mode. For example, referring to FIG. 3, when a boot update is performed, after updating a power module, a relay board, a main board of the power cabinet in this order, a main board of the dispenser is updated, so that the system normally operates. In contrast, in the case of a normal application update, after updating the main board of the dispenser, the main board, the relay board, and the power module of the power cabinet need to be updated in this order. The controller 120 provides a function of setting an order of components to be updated by reflecting this characteristic.

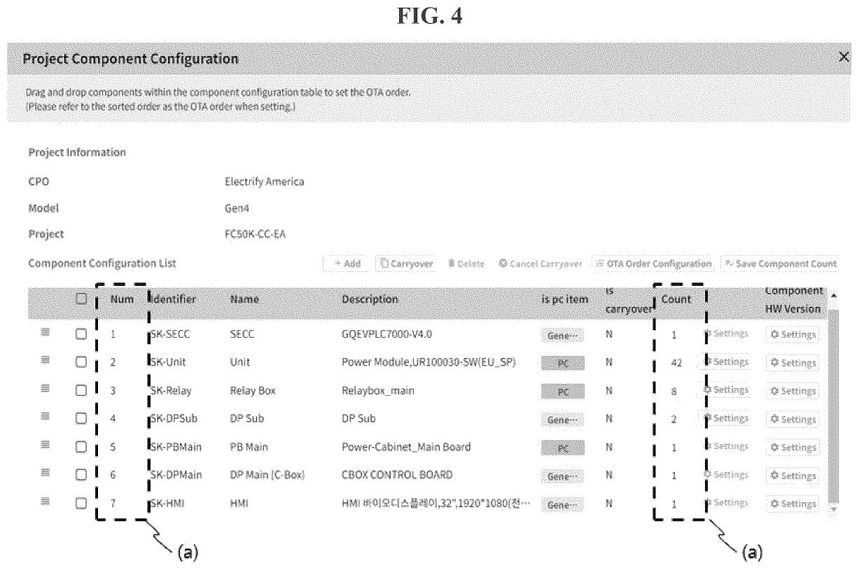

For example, the controller 120 may change the order according to a mode selected by the user to flexibly adjust an order difference between the boot update and the application update. If the update order is not changed, the system is restricted to perform only one of the boot update and the application update. In order to solve this restriction, as illustrated in (a) of FIG. 4, the controller 120 may allow the update order of the respective components to be selectively changed to an order desired by the user to respond to various update requests and increase the efficiency of the system. By doing this, the components of the charger system may be ensured to be updated in an accurate order and the update failure or error may be minimized.

According to the exemplary embodiment, the controller 120 may receive information about the number of one or more components included in the power cabinet and the dispenser and ID order information from the user through the communication unit 110. This information is necessary to accurately reflect the number of components and the update order which vary depending on the maximum output specification of the charger system. The number information received from the user plays an important role in appropriately updating the components in the system and the controller 120 may accurately update the components based on the information.

Depending on the output specification of the charger system, the number of components, such as the power module, may vary. For example, if the number of power modules is changed, the number of relay boards also varies due to the influence thereof. The controller 120 may receive the number information from the user as illustrated in (b) of FIG. 4 to dynamically adjust the number of charger components in accordance with the specification required by the system. This process supports the charger system to exhibit optimal performances.

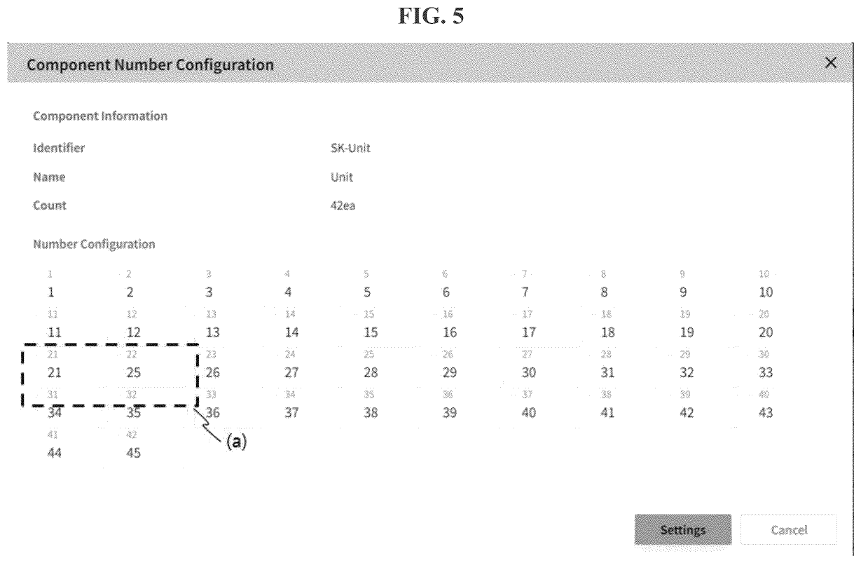

For example, for one or more components which need to be updated, such as the power module, ID numbers may not be sequential. In response to this, the controller 120 may receive the ID number information of the components from the user, thereby processing ID configurations which are not sequential. For example, as illustrated in FIG. 5, an ID number of the power module is set by the user by means of a “number configuration” menu and the ID number may be set by skipping missing IDs. For example, if the ID of the power module is set to be Nos. 21 and 25 (see (a) of FIG. 5), ID Nos. 22, 23, and 24 are processed as missing number to be skipped. By doing this, IDs which are not sequential can be configured and the controller 120 may skip the missing ID and update only necessary components. By doing this, the controller may efficiently update the components in response to non-sequential ID configurations.

According to the exemplary embodiment, the controller 120 may transmit update status information for each of one or more components included in the power cabinet and the dispenser to the user through the communication unit 110.

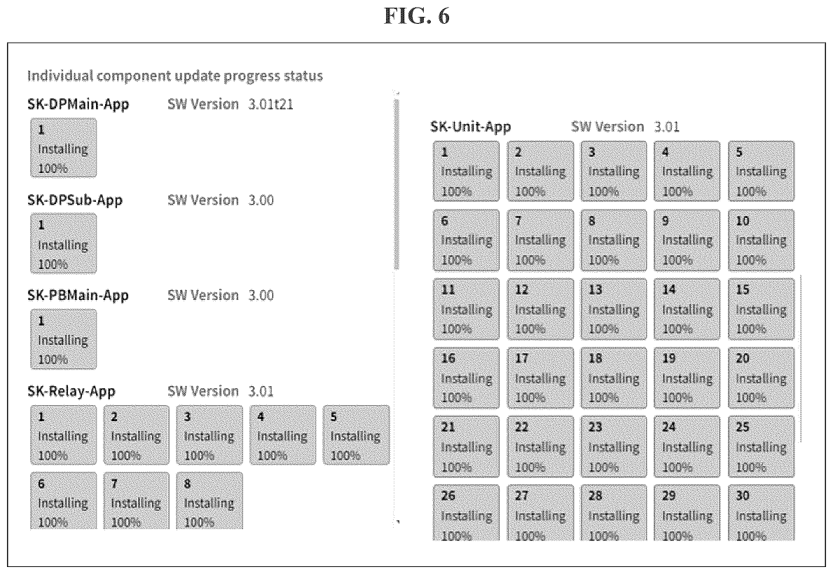

For example, in order to effectively manage the update progress status for each component of the charger system, the controller 120 may provide the update status information of each component to the user as illustrated in FIG. 6. To this end, the controller 120 may transmit the update status information of one or more components included in the power cabinet and the dispenser in real time through the communication unit 110. The user may identify the entire progress status at a glance based on this information and review a remaining progress status for the component which has not been updated to efficiently identify and manage the update progress status.

According to the exemplary embodiment, the controller 120 may selectively update some of one or more components included in the power cabinet and the dispenser according to a predetermined criterion.

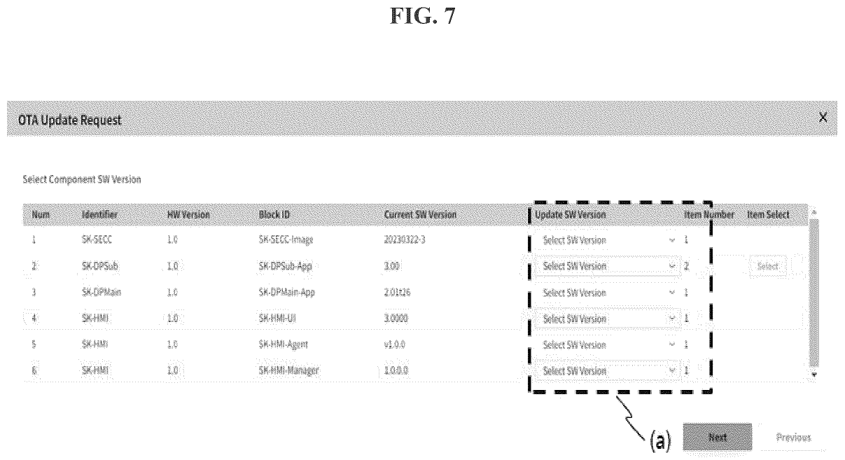

Referring to FIG. 7, the controller 120 may selectively update software for various components included in the charger. The components of the charger need to be periodically updated to optimize the performance of the system and this update may include performance improvement, error correction, and security patch. When it is necessary to update only some software among various components which configure the system, the controller 120 may select only the necessary component according to a predetermined criterion ((a) of FIG. 7) to perform the update. For example, like the power module, if there is a plurality of same types of components, only some power modules may be updated as needed, instead of updating all the power modules at one time.

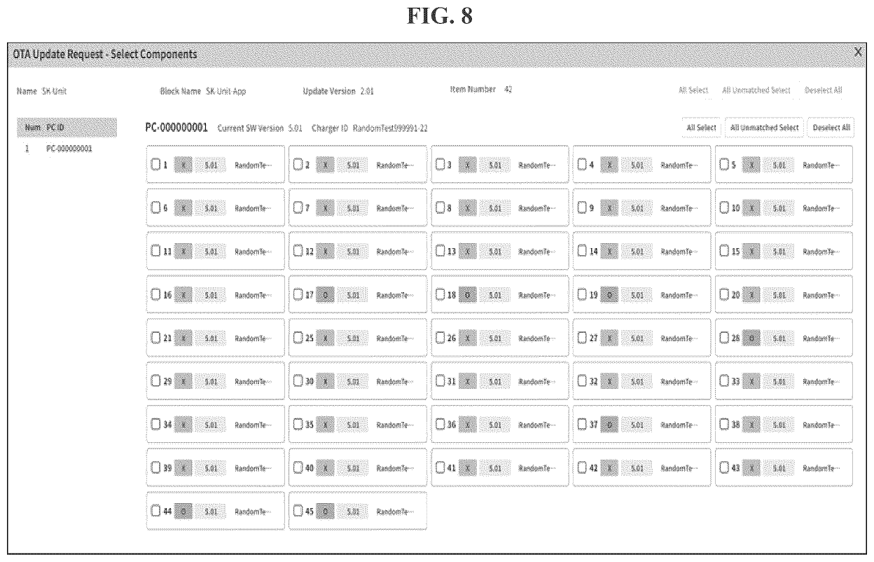

FIG. 8 illustrates an exemplary embodiment configured by 42 power modules. At this time, the update may be performed by a controller area network (CAN) communication. The CAN communication is efficient to quickly transmit data between a plurality of devices, but may sensitively respond to the disturbances or communication errors. If the update of some components fails due to the disturbance during the update process, the controller 120 may select a component which has not been updated to perform an additional update using a selective update function. By doing this, all the necessary components may be ensured to be normally updated without stopping the update of the charger system.

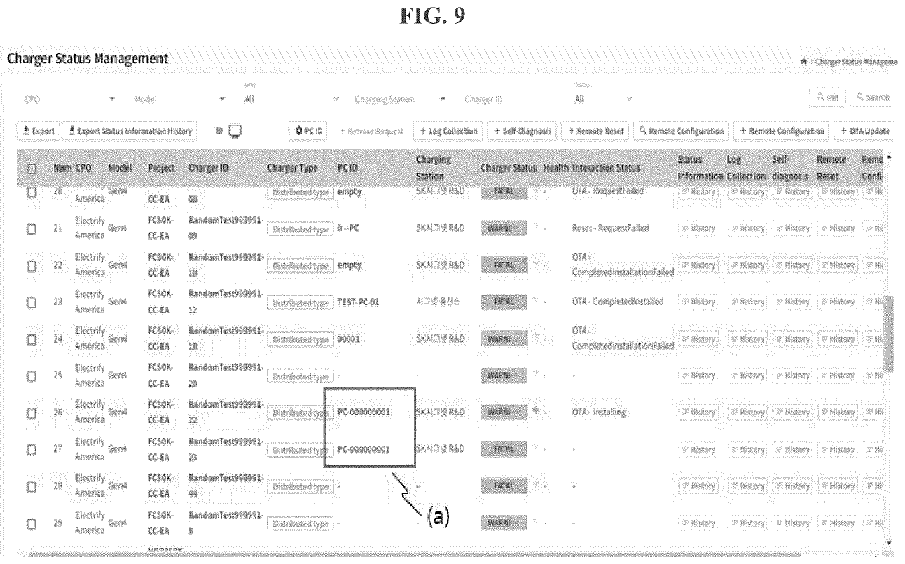

In order to update software of the charger, an update plan in consideration of the entire structure of the charger is necessary. Generally, the charger is configured with a 2DP/1PC structure, but the structure may vary depending on various specifications, such as 1DP/1PC or 4DP/1PC. Referring to FIG. 9, the controller 120 may set power cabinet IDs for every dispenser ((a) of FIG. 9) to distinguish the plurality of dispensers connected to one power cabinet to identify dispensers connected to the same power cabinet and perform the update based thereon. This structure helps systematically and efficiently manage the update of the charger.

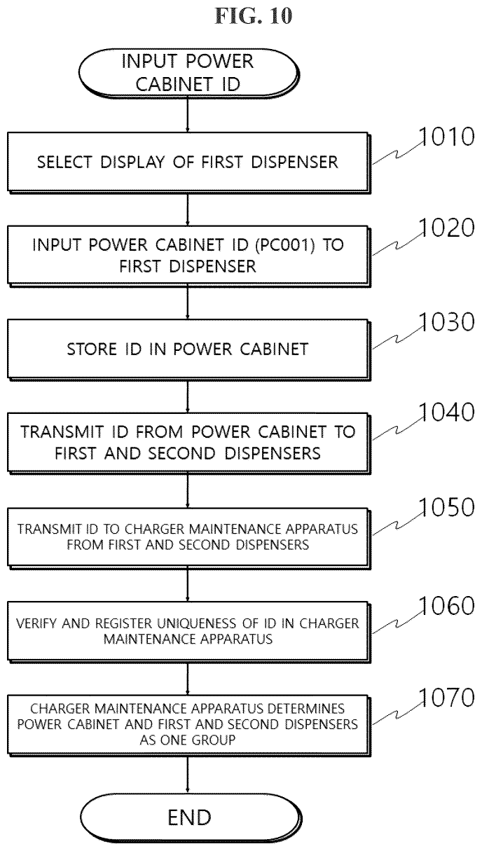

FIG. 10 illustrates a method of inputting an ID of a power cabinet to a charger configured by one power cabinet and two dispensers. Referring to FIG. 10, a power cabinet ID setting procedure is performed as follows. First, a user may select a display of a first dispenser as a device to input a cabinet ID in step 1010 and input a power cabinet ID in step 1020. If a unique power cabinet ID (for example, PC001) is input from a first dispenser, the corresponding ID is stored in the power cabinet in step 1030. Next, the stored ID is transmitted from the power cabinet to the first dispenser and the second dispenser in step 1040.

The first dispenser and the second dispenser transmit the received ID to the charger maintenance apparatus again in step 1050 and the charger maintenance apparatus verifies and registers the uniqueness of the received power cabinet ID in step 1060. Finally, the charger maintenance apparatus configures the power cabinet, the first dispenser, and the second dispenser to be set as one group and managed in step 1070. When all the procedures are completed, the ID setting process ends. In the above example, a charger environment configured by one power cabinet and two dispensers has been described, but the power cabinet ID setting procedure may be performed in the similar manner even in the charger environment configured by more dispensers.

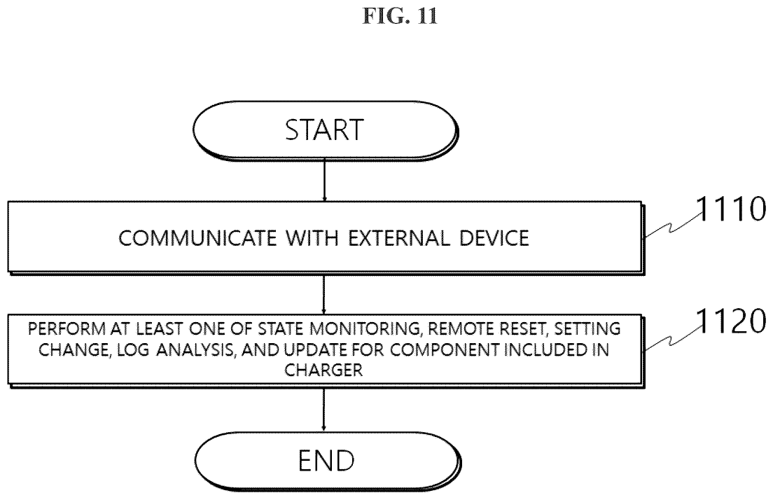

FIG. 11 is a flowchart illustrating a charger maintenance method according to an exemplary embodiment.

According to an exemplary embodiment, the charger maintenance apparatus may be a computing device including one or more processors and a memory which stores one or more programs executed by one or more processors.

According to the exemplary embodiment, the charger maintenance apparatus may perform the communication with an external device in step 1110 and perform at least one of state monitoring, remote reset, setting change, log analysis, and update for one or more components included in the charger in step 1120.

Among the exemplary embodiments of FIG. 11, embodiments that overlap the contents described with reference to FIGS. 1 to 10 are omitted.

An aspect of the present disclosure may also be implemented as computer-readable codes written on a computer-readable recording medium. Codes and code segments which implement the program may be easily deduced by a computer programmer in the art. The computer readable recording medium may include all kinds of recording devices in which data, which are capable of being read by a computer system, are stored. Examples of the computer-readable recording media may include ROM, RAM, CD-ROM, magnetic tape, floppy disk, optical disk and the like. Further, the computer readable recording medium may be distributed in computer systems connected through a network to be written and executed with a computer readable code in a distributed manner.

For now, the present disclosure has been described with reference to the exemplary embodiments. It is understood to those skilled in the art that the present disclosure may be implemented as a modified form without departing from an essential characteristic of the present disclosure. Accordingly, the scope of the present disclosure is not limited to the above-described embodiment, but should be construed to include various embodiments within the scope equivalent to the description of the claims.

What is claimed is:

1. A charger maintenance apparatus, comprising:
a communication unit which communicates with an external device; and
a controller which performs at least one of state monitoring, remote reset, setting change, log analysis, and update for one or more components included in a charger, by means of the communication unit.

2. The charger maintenance apparatus according to claim 1, wherein the charger is configured by a power cabinet to supply power and one or more dispensers which are connected to the power cabinet to perform charging.

3. The charger maintenance apparatus according to claim 2, wherein the controller communicates with the one or more dispensers through the communication unit.

4. The charger maintenance apparatus according to claim 3, wherein when the update is performed, the controller determines the power cabinet as a master device according to a predetermined criterion to update one or more components included in the power cabinet and one or more components included in the one or more dispensers connected to the power cabinet.

5. The charger maintenance apparatus according to claim 3, wherein when the update is performed, the controller determines at least one of the one or more dispensers as a master dispenser and determines the other dispensers as slave dispensers, according to a predetermined criterion.

6. The charger maintenance apparatus according to claim 4, wherein the master dispenser updates one or more components included therein and one or more components included in the power cabinet connected thereto and the slave dispensers update one or more components included therein.

7. The charger maintenance apparatus according to claim 6, wherein the controller determines the master dispenser based on a CPU usage (%), a memory usage (%), and a network occupancy (%) of each of the one or more dispensers.

8. The charger maintenance apparatus according to claim 5, wherein the controller determines at least two or more master dispensers and determines one of the at least two or more master dispensers as a primary master dispenser which updates one or more components included in the power cabinet.

9. The charger maintenance apparatus according to claim 8, wherein the controller determines the other one or more master dispensers excluding the primary master dispenser, among the at least two or more master dispensers, as a secondary master dispenser which simulates the same update process as the primary master dispenser.

10. The charger maintenance apparatus according to claim 9, wherein if an error occurs during the update of the primary master dispenser, the controller calls an update process at a predetermined reference timing from any one of the one or more secondary master dispensers to replace the update of the primary master dispenser.

11. The charger maintenance apparatus according to claim 10, wherein the controller compares the update process of the primary master dispenser at the predetermined reference timing and the called update process of the secondary master dispenser and if the update processes are different, the controller replaces the update of the primary master dispenser using the called update process and if the update processes are the same, calls the update process of another secondary master dispenser again.

12. The charger maintenance apparatus according to claim 3, wherein the controller determines an update order of one or more components included in the power cabinet and the dispenser according to a predetermined mode.

13. The charger maintenance apparatus according to claim 3, wherein the controller receives number information and ID order information of each of one or more components included in the power cabinet and the dispenser from a user, through the communication unit.

14. The charger maintenance apparatus according to claim 3, wherein the controller transmits update status information for any of one or more components included in the power cabinet and the dispenser to a user through the communication unit.

15. The charger maintenance apparatus according to claim 3, wherein the controller selectively updates some of one or more components included in the power cabinet and the dispenser according to a predetermined criterion.

16. A charger maintenance method which is carried out on a computing device including one or more processors and a memory which stores one or more programs executed by the one or more processors, the method comprising:
a communication step of communicating with an external device; and
a control step of performing at least one of state monitoring, remote reset, setting change, log analysis, and update for one or more components included in a charger, by means of the communication step.

17. The charger maintenance method according to claim 16, wherein the charger is configured by a power cabinet to supply power and one or more dispensers which are connected to the power cabinet to perform charging.

18. The charger maintenance method according to claim 17, wherein in the communication step, communication is performed with the one or more dispensers, and
wherein in the control step, when the update is performed, the power cabinet is determined as a master device according to a predetermined criterion to update one or more components included in the power cabinet and one or more components included in one or more dispensers connected to the power cabinet.

19. The charger maintenance method according to claim 17, wherein in the communication step, communication is performed with the one or more dispensers, and
wherein in the control step, when the update is performed, at least one of the one or more dispensers is determined as a master dispenser and the others are determined as slave dispensers according to a predetermined criterion.

20. The charger maintenance method according to claim 19, wherein the master dispenser updates one or more components included therein and one or more components included in the power cabinet connected thereto and the slave dispensers update one or more components included therein.
